(19) United States
(12) Patent Application Publication
(10) Pub. No.: US 2011/0315022 A1
(43) Pub. Date: Dec. 29, 2011

(54) DUAL-PURPOSE GRILLING DEVICE

(75) Inventor: Junping Huang, Zhangzhou (CN)

(73) Assignee: TSANN KUEN (ZHANGZHOU) ENTERPRISE CO., LTD., Fujian (CN)

(21) Appl. No.: 13/254,256

(22) PCT Filed: Feb. 25, 2010
(86) PCT No.: PCT/CN2010/070744

§ 371 Date: Sep. 1, 2011

(30) Foreign Application Priority Data
Mar. 2, 2009 (CN) 200920136952.0

(51) Int. Cl. A47J 37/00

(52) U.S. Cl. 99/340

(57) ABSTRACT

The dual-purpose grilling device of the present invention, it relates to a grilling device which can be inclined for roasting or be level for toasting. The bottom seat of said grilling device has a grilling plate with an electric heating tube, and an upper cover with a handle is disposed on said bottom seat; the grilling plate inclines forward and downward in the roast status, the oil box is beneath the front of the grilling plate for containing the oil flowed from the grilling plate; the oil box is beneath the front of the bottom seat and the grilling plate is level in the toast status. The present invention solves the problem of the single using manner of the grilling device with a simple technical solution.

### FIELD OF THE INVENTION

The present invention relates to a grilling device which can be inclined for roasting or be level for toasting.

### BACKGROUND OF THE INVENTION

The conventional electric grilling device, it usually has a grilling plate equipped with an electric heating tube and said grilling plate is disposed on the bottom seat, an upper cover has a handle is disposed on said bottom seat. The grilling plate of the grilling device used for roasting is inclined, so that the oil from the heated meat will flow forward and downward into the oil box. However, the grilling plate of the grilling device used for toasting is level, so that the bread will be convenient to be fetched. Thereby, the conventional grilling device can not incorporate the functions of roasting and toasting on a single grilling device.

### SUMMARY OF THE INVENTION

The object of the present invention is to provide a dual-purpose grilling device, which can both be inclined for roasting and be level for toasting with a simple structure.

The technical solution of the present invention is: a dual-purpose grilling device, the bottom seat of which has a grilling plate equipped with an electric heating tube, an upper cover with a handle is disposed on said bottom seat; wherein when the grilling device is in the roast status, the grilling plate inclines forward and downward; an oil box is positioned beneath the front the grilling plate for containing the oil flowed from the grilling plate; when the grilling device is in the toast status, the oil box is positioned beneath the front of the bottom seat and the grilling plate is level.

The top surface of said oil box inclines backward and downward.

When the grilling device is in the toast status, the oil box is turned over and positioned beneath the front of the bottom seat.

The dual-purpose grilling device of the present invention, the grilling plate inclines forward and downward according to the requirement of the roasting; when the device is used for roasting, the oil box is positioned beneath the front of the grilling plate to contain the oil flowed from the grilling plate; when the device is used for toasting, the oil box is positioned beneath the front of the bottom seat and the grilling plate is level; thus the requirement of toasting is satisfied. Compared to the conventional grilling device, said dual-purpose grilling device only changes the using manners of the oil box: the oil box is positioned beneath the front of the grilling plate or positioned beneath the front of the bottom seat instead of hanging beneath the front of the grilling plate. Thereby it needs no additional parts, the structure is simple, it is convenient for operation. The top surface of the oil box inclines backward and downward, so it is convenient for the oil box to close to the grilling for containing oil when the roast status; and to be turned over to positioned beneath the front of the bottom seat for supporting the grilling plate steadily when the toast status.

### BRIEF DESCRIPTION OF THE DRAWINGS

FIG. 1 is a perspective structural view of the main body of the grilling device of an embodiment of the dual-purpose grilling device of the present invention.

FIG. 2 is a perspective structural view of the oil box of the embodiment of FIG. 1.

FIG. 3 is a perspective structural view of the turned over oil box of the embodiment of FIG. 1.

FIG. 4 is the side structural view of the embodiment of FIG. 1 when the grilling device is in the roast status.

FIG. 5 is the perspective structural view of the embodiment of FIG. 1 when the grilling device is in the roast status.

FIG. 6 is the side structural view of the embodiment of FIG. 1 when the grilling device is in the toast status.

FIG. 7 is the perspective structural view of the embodiment of FIG. 1 when the grilling device is in the toast status.

### DETAILED DESCRIPTION OF THE EMBODIMENTS

A preferred embodiment of the dual-purpose grilling device of the present invention comprises a main body and an oil box.

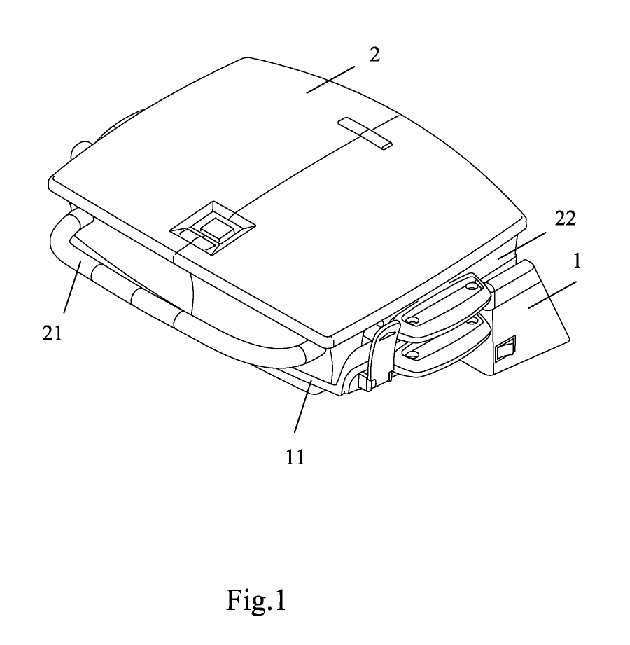

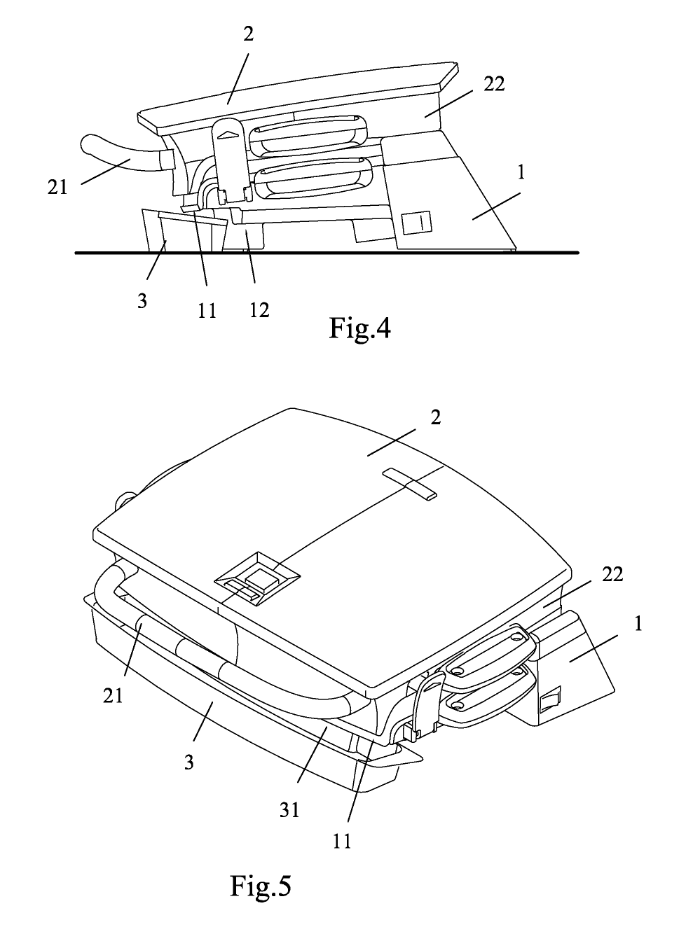

The perspective structure of the main body is showed in FIG. 1, FIG. 4 and FIG. 5. Said main body comprises a bottom seat 1 and an upper cover 2.

The bottom seat 1 has a lower grilling plate 11 with an electric heating tube. Said lower grilling plate 11 inclines downward and forward and its grilling surface faces upward, a supporting leg 12 is disposed in the front portion of the bottom seat 1, the front end of the bottom seat 1 of the supporting leg 12 has a retaining space for accommodating the oil box 3. The rear portion of said bottom seat 1 is disposed with a hinge for connecting the upper cover 2.

The front end of the upper cover 2 has a handle 21. The lower surface of the upper cover 2 has an upper grilling plate 22 equipped with an electric heating tube.

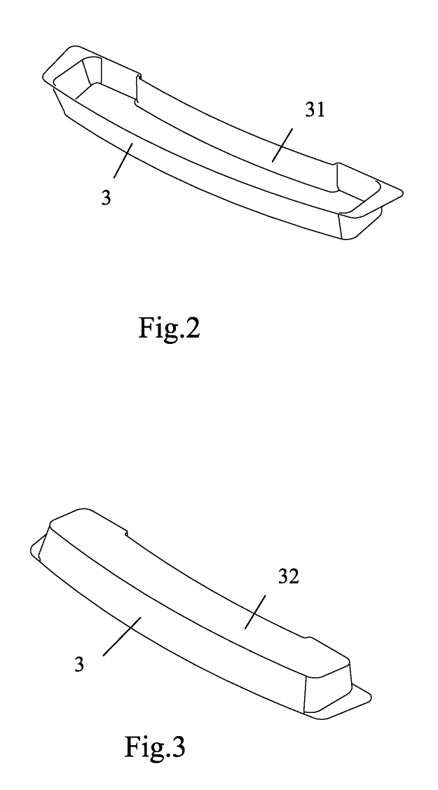

The structure of the oil box 3 is showed in FIG. 2. The shape of the oil box 3 is a long strip, its top portion is open; the hollow groove 31 of the oil box 3 is depressed inward for containing the oil, the two sides of the oil box 3 respectively extends outward to form a side wing 33. Please refer to FIG. 3, the bottom portion 32 of the oil box 3 is flat, some friction dots can be disposed on the bottom portion 32. It can be inferred from the FIG. 4: the top surface of the oil box 3 inclines backward and downward and forms a sloped stair surface.

Please refer to FIG. 4 and FIG. 5, said dual-purpose grilling device is in the roast status, the supporting leg 12 of the front portion of the bottom seat 1 touch down, the lower grilling plate 11 inclines forward and downward. The oil box 3 is positioned beneath the front of the lower grilling plate 11 for containing the oil flowed from the lower grilling plate 11. When the upper cover 2 is buckled on the lower grilling plate 11 of the bottom seat 1. said upper grilling plate 22 inclines forward and downward and its grilling surface faces downward.

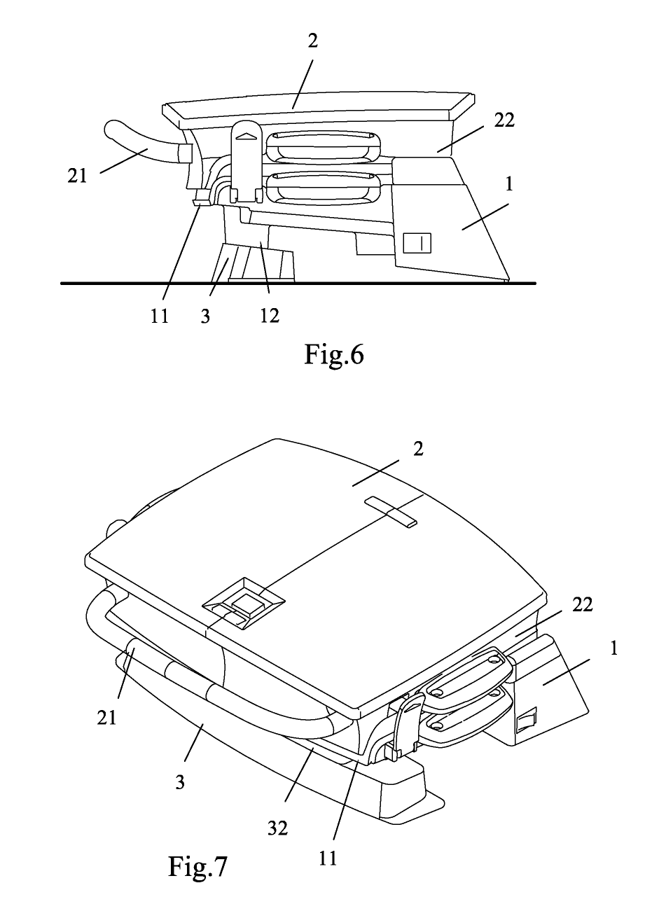

Please refer to FIG. 6 and FIG. 7, said dual-purpose grilling device is in the toast status, the oil box 3 is turned over and beneath the supporting leg 12 of the front portion of the bottom seat 1, the frames and the side wings 33 of the oil box 3 are used for supporting, the bottom portion 32 of the oil box 3 supports the supporting legs 12 of the front portion of the bottom seat 1 so that the lower grilling plate 11 is lifted to be level. When the upper cover 2 is buckled on the lower grilling plate 11 of the bottom seat 1, said upper grilling plate 22 is level and its grilling surface faces downward.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

### INDUSTRIAL APPLICABILITY

The dual-purpose grilling device of the present invention, its structure is simple, the design is ingenious, when the device is in the roast status, the oil box is positioned beneath the front of the grilling plate for containing the oil flowed from the grilling plate; when the device is in the toast status, the oil box is positioned beneath the front of the bottom seat and the grilling plate is level; the problem of single using manner of the conventional grilling device is solved with a simple technical solution.

1. A dual-purpose grilling device, the bottom seat of which has a grilling plate equipped with an electric heating tube, an upper cover with a handle is disposed on said bottom seat; wherein when the grilling device is in the roast status, the grilling plate inclines forward and downward; an oil box is positioned beneath the front the grilling plate for containing the oil flowed from the grilling plate; when the grilling device is in the toast status, the oil box is positioned beneath the front of the bottom seat and the grilling plate is level.

2. The dual-purpose grilling device according to claim 1, wherein the top surface of said oil box inclines backward and downward, the side surface of which is a sloped stair surface.

3. The dual-purpose grilling device according to claim 1, wherein when the grilling device is in the toast status, the oil box is turned over and positioned beneath the front of the bottom seat.

4. The dual-purpose grilling device according to claim 3, wherein the front portion of said bottom seat has a supporting leg, a retaining space is designed between the supporting leg and the front end of the bottom seat.

5. The dual-purpose grilling device according to claim 3, wherein when the grilling device is in the toast status, the oil box is turned over and positioned beneath the supporting leg of the front and downside of the bottom seat.

6. The dual-purpose grilling device according to claim 1, wherein the two sides of the top surface of said oil box respectively extends to form a side wing.

7. The dual-purpose grilling device according to claim 2, wherein when the grilling device is in the toast status, the oil box is turned over and positioned beneath the front of the bottom seat.

8. The dual-purpose grilling device according to claim 7, wherein the front portion of said bottom seat has a supporting leg, a retaining space is designed between the supporting leg and the front end of the bottom seat.

9. The dual-purpose grilling device according to claim 7, wherein when the grilling device is in the toast status, the oil box is turned over and positioned beneath the supporting leg of the front and downside of the bottom seat.
